(19) United States
(12) Patent Application Publication
(10) Pub. No.: US 2025/0205824 A1
(43) Pub. Date: Jun. 26, 2025

(54) LASER PROCESSING METHOD

(71) Applicant: DISCO CORPORATION, Tokyo (JP)

(72) Inventors: Satoshi KUMAZAWA, Tokyo (JP); Masatoshi NAYUKI, Tokyo (JP); Keisuke NISHIMOTO, Tokyo (JP)

(21) Appl. No.: 18/978,349

(22) Filed: Dec. 12, 2024

(30) Foreign Application Priority Data
Dec. 21, 2023 (JP) 2023-215700

(51) Int. Cl. B23K 26/38

(52) U.S. Cl. CPC B23K 26/38

(57) ABSTRACT

A laser processing method includes: holding a back surface side of a workpiece by a holding table such that a front surface side of the workpiece is exposed; and applying a laser beam from a laser beam irradiation unit along a plurality of planned division lines from the front surface side of the workpiece held by the holding table. In the applying, the laser beam is applied while changing an irradiation position of the laser beam on a front surface of the workpiece by a laser beam scanning unit disposed between an oscillator that oscillates the laser beam and a condenser that condenses light from the oscillator.

### CROSS-REFERENCE TO RELATED APPLICATION(S)

The present application claims priority to and incorporates by reference the entire contents of Japanese Patent Application No. 2023-215700 filed in Japan on Dec. 21, 2023.

The present disclosure relates to a laser processing method for performing laser processing along planned division lines of a workpiece having image sensor elements.

### BACKGROUND

As a method of dividing a workpiece such as a semiconductor wafer along planned division lines, a method of dividing the workpiece by performing laser processing on the planned division lines is known (see, for example, JP H6-120334 A). In such laser processing, the workpiece is continuously processed along the planned division lines by thermal energy generated in irradiation regions of the workpiece by applying a laser beam.

However, in the laser processing disclosed in JP H6-120334 A described above, the thermal energy may be concentrated and debris (processing debris) may be generated in the irradiation regions of the workpiece, and there is a problem that this debris adheres to a surface of the workpiece to deteriorate the quality. Therefore, a laser processing method has been proposed in which a water-soluble protective film is formed on the surface of the workpiece, and the workpiece is irradiated with a laser beam through the protective film (see, for example, JP 2006-140311 A). By washing the protective film with water after laser processing, the protective film can be removed along with any debris adhering to the protective film, and the surface of the workpiece can be protected.

However, when laser processing is performed on planned division lines of a workpiece having image sensor elements as devices, a defect (so-called surface burning) such as a mark of laser irradiation may occur on a part of sensor element portion. This mark occurs when the debris generated by the laser beam is relatively large.

From this, it is presumed that when the large debris is flying in the air, a laser beam of a next pulse hits the debris, so that the laser beam is scattered, and the sensor element portion is irradiated with scattered light to leave a mark. For the purpose of solving this problem, in order to reduce a size of the generated debris, it is conceivable to reduce a laser irradiation spot, reduce pulse energy, or the like, but there is a problem that productivity is lowered.

Therefore, there is a task of providing a laser processing method for relatively reducing a size of debris generated by a laser beam when laser processing is performed on a workpiece having image sensor elements as devices.

### SUMMARY

A laser processing method according to the present disclosure is for performing laser processing on a workpiece along a plurality of planned division lines that intersects each other on a front surface of the workpiece. The workpiece has a plurality of devices formed in respective regions defined by the planned division lines. Each of the devices includes an image sensor element. The laser processing method includes: holding a back surface side of the workpiece by a holding table such that a front surface side of the workpiece is exposed; and applying a laser beam from a laser beam irradiation unit along the planned division lines from the front surface side of the workpiece held by the holding table. In the applying, the laser beam is applied while changing an irradiation position of the laser beam on the front surface of the workpiece by a laser beam scanning unit disposed between an oscillator that oscillates the laser beam and a condenser that condenses light from the oscillator.

### BRIEF DESCRIPTION OF THE DRAWINGS

FIG. 1 is a perspective view illustrating a workpiece to be processed by a laser processing method according to a first embodiment;

FIG. 2 is a perspective view schematically illustrating a configuration example of a laser processing device that performs the laser processing method according to the first embodiment;

FIG. 3 is a diagram illustrating a configuration example of a laser beam irradiation unit of the laser processing device illustrated in FIG. 1;

FIG. 4 is a flowchart illustrating a flow of the laser processing method according to the first embodiment;

FIG. 5 is a side view schematically illustrating a holding step of the laser processing method illustrated in FIG. 4 in a partial cross section; and

FIG. 6 is a side view schematically illustrating a laser irradiation step of the laser processing method illustrated in FIG. 4 in a partial cross section.

### DETAILED DESCRIPTION

Embodiments of the present disclosure will be described in detail with reference to the drawings. The present invention is not limited by contents described in the following embodiments. In addition, components described below include those that can be easily assumed by those skilled in the art and those that are substantially the same. Furthermore, configurations described below can be appropriately combined. In addition, various omissions, substitutions, or changes in the configurations can be made without departing from the gist of the present invention.

### First Embodiment

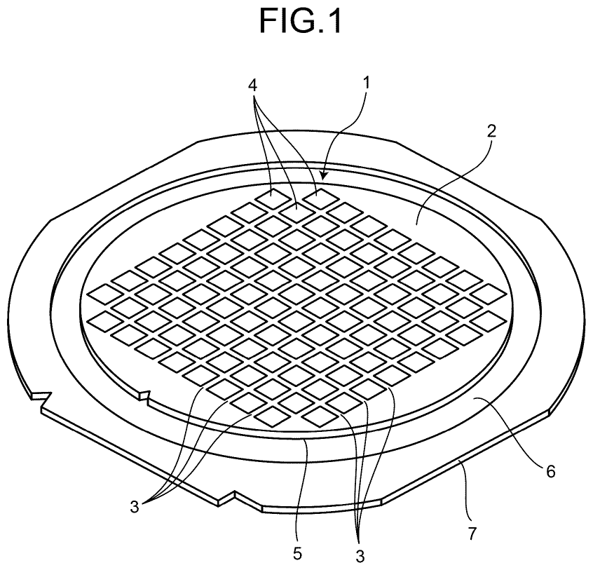

A laser processing method according to a first embodiment of the present disclosure will be described with reference to the drawings. FIG. 1 is a perspective view illustrating a workpiece to be processed by a laser processing method according to a first embodiment. The laser processing method according to the first embodiment is a method of performing laser processing on a workpiece 1 illustrated in FIG. 1.

### Workpiece

As illustrated in FIG. 1, the workpiece 1 to be processed by the laser processing method according to the first embodiment is, for example, a disk-shaped semiconductor wafer having a silicon substrate, a sapphire substrate, a gallium substrate, a SiC substrate, or the like as a substrate. In the first embodiment, as illustrated in FIG. 1, in the workpiece 1, a plurality of devices 4 are formed in respective regions defined by a plurality of planned division lines 3 intersecting each other on a front surface 2.

The device 4 is an image sensor element. In the first embodiment, the device 4 is a complementary metal-oxide-semiconductor (CMOS) image sensor device (also referred to as an imaging element). The workpiece 1 is subjected to laser processing along the planned division lines 3 to be divided into individual devices 4.

In the first embodiment, as illustrated in FIG. 1, a disk-shaped adhesive tape 6 having a diameter larger than that of the workpiece 1 is attached to a back surface 5 on a back side of the front surface 2 of the workpiece 1, and an annular frame 7 is attached to an outer edge portion of the adhesive tape 6 and supported in an opening of the frame 7.

### Laser Processing Device

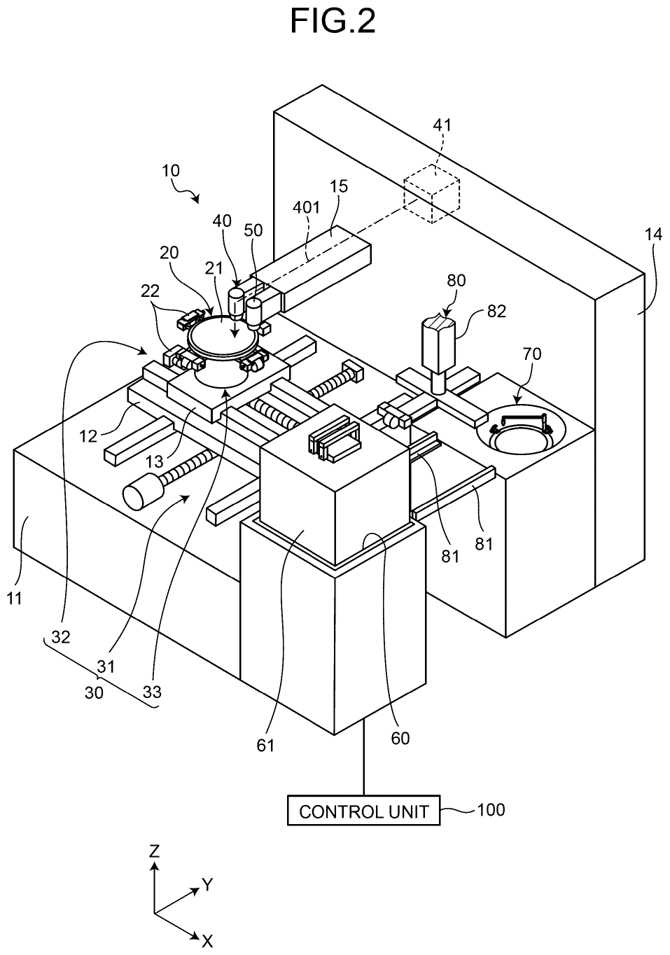

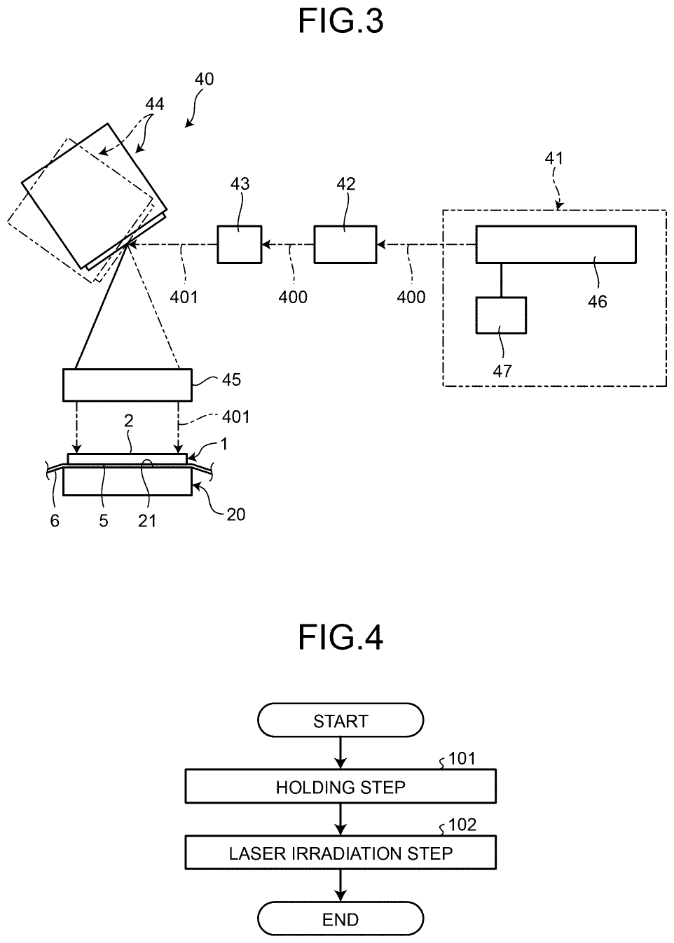

The laser processing method according to the first embodiment is performed by a laser processing device 10 illustrated in FIG. 2. FIG. 2 is a perspective view schematically illustrating a configuration example of the laser processing device that performs the laser processing method according to the first embodiment. FIG. 3 is a diagram illustrating a configuration example of a laser beam irradiation unit of the laser processing device illustrated in FIG. 2.

As illustrated in FIG. 2, the laser processing device 10 includes a holding table 20, a movement unit 30, a laser beam irradiation unit 40, an imaging unit 50, a cassette elevator 60, a cleaning unit 70, a conveyance unit 80, and a control unit 100.

The holding table 20 has a disk shape, and a holding surface 21 that is flat along the horizontal direction and holds the workpiece 1 is formed of porous ceramic or the like. The holding table 20 is provided movably, by the movement unit 30, over a processing region below the laser beam irradiation unit 40 and a carrying-in/out region separated from below the laser beam irradiation unit 40 where the workpiece 1 is carried in/out.

The holding table 20 is connected to a vacuum suction source (not illustrated), and sucks and holds the workpiece 1 placed on the holding surface 21 by being sucked by the vacuum suction source. In the first embodiment, the holding table 20 sucks and holds the back surface 5 side of the workpiece 1 via the adhesive tape 6. As illustrated in FIG. 2, a plurality of clamp units 22 that clamp the frame 7 are provided around the holding table 20.

The movement unit 30 relatively moves the holding table 20 and the laser beam irradiation unit 40. The movement unit 30 includes at least a Y-axis movement unit 31 that is an indexing feeding unit that moves the holding table 20 in a Y-axis direction parallel to a horizontal direction, an X-axis movement unit 32 that is a processing feeding unit that moves the holding table 20 in an X-axis direction parallel to the horizontal direction and orthogonal to the Y-axis direction, and a rotation movement unit 33 that rotates the holding table 20 about an axis parallel to a Z-axis direction parallel to a vertical direction.

The Y-axis movement unit 31 is placed on a device body 11, and moves the holding table 20 in the Y-axis direction by moving a movement plate 12, on which the X-axis movement unit 32 is placed, in the Y-axis direction. The X-axis movement unit 32 is placed on the movement plate 12, and moves the holding table 20 in the X-axis direction by moving a second movement plate 13, on which the rotation movement unit 33 is placed, in the X-axis direction. The rotation movement unit 33 is placed on the second movement plate 13 and supports the holding table 20, thereby rotating the holding table 20 about the axis.

The Y-axis movement unit 31 moves the X-axis movement unit 32, the second movement plate 13, the rotation movement unit 33, and the holding table 20 in the Y-axis direction with the movement plate 12. The X-axis movement unit 32 moves the rotation movement unit 33 and the holding table 20 in the X-axis direction with the second movement plate 13.

The Y-axis movement unit 31 and the X-axis movement unit 32 include a known ball screw rotatable about an axis thereof, a known motor that rotates the ball screw about the axis, and a known guide rail that movably supports the movement plates 12 and 13 in the X-axis direction or the Y-axis direction. The rotation movement unit 33 includes a known motor or the like that rotates the holding table 20 about an axis thereof.

As illustrated in FIG. 2, a part of the laser beam irradiation unit 40 is provided at a tip of a supporting column 15 whose base end portion is supported by an erected wall 14 erected from an end of the device body 11 in the Y-axis direction. The laser beam irradiation unit 40 irradiates the workpiece 1 held by the holding table 20 with a laser beam 401 to perform laser processing. As illustrated in FIG. 3, the laser beam irradiation unit 40 includes a laser beam oscillation unit 41, an optical system 42, a wavelength conversion element 43, a laser beam scanning unit 44, and a condenser 45.

The laser beam oscillation unit 41 includes an oscillator 46 and a repetition frequency setting unit 47. The oscillator 46 is a device that oscillates a laser beam having a predetermined wavelength. Used as a suitable laser beam oscillation unit in the first embodiment is a unit that oscillates a laser beam having a wavelength of about 1 μm by exciting a crystal such as YAG doped with neodymium (Nd) ions or the like by a laser diode (LD).

The repetition frequency setting unit 47 is a unit that sets the repetition frequency of the laser beam oscillated by the oscillator 46. Used as a suitable repetition frequency setting unit in the first embodiment is a unit that sets the repetition frequency to a double and, based on the above-described laser beam having the wavelength of about 1 μm, oscillates a laser beam 400 having a wavelength of about 514 nm, which is a doubled wave of the laser beam having the wavelength of about 1 μm.

In the first embodiment, the laser beam oscillation unit 41 is controlled by the control unit 100 to oscillate a pulse laser beam having a repetition frequency of 100 kHz or more and 100 MHz or less, an average output of 1 W or more and 1000 W or less, and a pulse width of 20 ps or less.

The optical system 42 includes at least one of predetermined optical instruments such as a beam diameter adjuster and an output adjuster, and transmits the laser beam 400 oscillated from the laser beam oscillation unit 41. The wavelength conversion element 43 is an element that converts the wavelength of the laser beam 400 transmitted by the optical system 42. In the first embodiment, the laser beam 400 having a wavelength of about 514 nm oscillated by the laser beam oscillation unit 41 is converted into a laser beam 401 having a wavelength of about 355 nm having absorbency for the workpiece 1, which is a tripled wave of the original laser beam having a wavelength of about 1 μm. Further, in the present disclosure, the wavelength conversion element 43 may convert the laser beam into a laser beam of a doubled wave or a quadrupled wave.

In the laser beam irradiation unit 40 according to the first embodiment, since the wavelength conversion element 43 is provided on the downstream side of the optical system 42 in a traveling direction of the laser beams 400 and 401, the wavelength of the laser beam 400 passing through the optical system 42 can be caused to be longer than the wavelength of the laser beam 401 to be finally applied, so that damage to the optical system 42 can be suppressed.

As illustrated in FIG. 3, the laser beam scanning unit 44 is disposed between the oscillator 46 and the condenser 45. More specifically, the laser beam scanning unit 44 is disposed on the downstream side of the optical system 42 and the wavelength conversion element 43 provided on the downstream side of the laser beam oscillation unit 41 including the oscillator 46. The laser beam scanning unit 44 changes an irradiation position of the laser beam 401 on the holding surface 21 of the holding table 20 in an XY plane.

In the first embodiment, the laser beam scanning unit 44 includes a galvano scanner, a resonant scanner, an acousto-optic deflection element, or a polygon mirror. The laser beam scanning unit 44 is controlled by the control unit 100 to oscillate the laser beam 401 in the X-axis direction and the Y-axis direction to guide the laser beam 401 to the condenser 45.

The condenser 45 has a circular shape having a diameter equal to or larger than that of the holding surface 21 of the holding table 20 in the XY plane, and is provided so as to cover a portion above the holding surface 21 of the holding table 20 at the time of being located below the laser beam irradiation unit 40. The condenser 45 condenses the pulse laser beam 401 oscillated by the oscillator 46 and scanned by the laser beam scanning unit 44. In the present disclosure, the condenser 45 may be smaller than the holding surface 21 of the holding table 20.

The condenser 45 is, for example, a large F0 lens having the above-described diameter or a large image-side telecentric objective lens having the above-described diameter. In either case, the optical axis is provided along the Z-axis direction. The condenser 45 applies the laser beam 401 in a direction parallel to the Z-axis direction which is the optical axis direction, that is, in a direction orthogonal to the holding surface 21 of the holding table 20, without depending on an incident angle of the laser beam 401 guided from the laser beam scanning unit 44.

The laser beam irradiation unit 40 sets a focal spot onto the front surface 2 of the workpiece 1 held by the holding table 20, irradiates the workpiece 1 with the laser beam 401 having a wavelength having absorbency along the planned division lines 3, and performs ablation processing on the planned division lines 3 of the workpiece 1 to divide the workpiece 1 into the individual devices 4. In the first embodiment, the laser beam irradiation unit 40 irradiates the workpiece 1 with the laser beam 401 having irradiation energy of 0.01 μJ or more and 10 μJ or less for each focal spot (corresponding to one irradiation region) on the front surface 2 of the workpiece 1. This is because when the irradiation energy for each focal spot is less than 0.01 μJ, processing does not occur, and when the irradiation energy for each focal spot exceeds 10 μJ, a defect (so-called surface burning) such as a mark of laser irradiation with the laser beam 401 may occur on a part of the devices 4.

In the first embodiment, in the laser beam irradiation unit 40, the repetition frequency (corresponding to a pulse frequency) of the laser beam 401 is 1 MHz or more and 100 MHz or less. This is because when the repetition frequency of the laser beam 401 is less than 1 MHz, the number of times of irradiation is reduced and the productivity is lowered, and when the repetition frequency of the laser beam 401 exceeds 100 MHz, it is necessary to increase the output of the laser beam in order to cause processing to occur, that is, the cost is increased and the laser oscillator is increased in size.

The imaging unit 50 is disposed at a position aligned with the condenser 45 of the laser beam irradiation unit 40 in the X-axis direction at the tip of the supporting column 15. The imaging unit 50 includes an imaging element that images a region to be divided of the workpiece 1 before laser processing held by the holding table 20. The imaging element is, for example, a charge-coupled device (CCD) imaging element or a complementary MOS (CMOS) imaging element. The imaging unit 50 images the workpiece 1 held by the holding table 20, obtains an image for performing alignment for aligning the workpiece 1 with the condenser 45 of the laser beam irradiation unit 40, and outputs the obtained image to the control unit 100.

On the cassette elevator 60, a cassette 61 that houses therein the workpiece 1 before and after laser processing is placed. The cassette elevator 60 moves the cassette 61 in the Z-axis direction. In the first embodiment, the cassette elevator 60 is disposed at an end on the carrying-in/out region side in the X-axis direction of the device body 11 and at an end away from the erected wall 14 in the Y-axis direction.

The cleaning unit 70 cleans the workpiece 1 after laser processing. The cleaning unit 70 is disposed at an end of the device body 11 on the carrying-in/out region side in the X-axis direction and at an end close to the erected wall 14 in the Y-axis direction.

The conveyance unit 80 conveys the workpiece 1 between the cassette 61, the holding table 20, and the cleaning unit. The conveyance unit 80 includes a pair of guide rails 81 on which the workpiece 1 to be taken in and out of the cassette 61 is placed, and a conveyance arm 82 which takes the workpiece 1 in and out of the cassette 61 and conveys the workpiece 1 between the guide rails 81, the holding table 20, and the cleaning unit 70.

The control unit 100 controls each component of the laser processing device 10 to cause the laser processing device 10 to perform the processing operation on the workpiece 1. The control unit 100 is a computer including an arithmetic processing device including a microprocessor such as a central processing unit (CPU), a storage device including a memory such as a read only memory (ROM) or a random access memory (RAM), and an input/output interface device. The arithmetic processing device of the control unit 100 performs arithmetic processing according to a computer program stored in the storage device, and outputs control signals for controlling the laser processing device 10 to each component of the laser processing device 10 via the input/output interface device.

The control unit 100 is connected to a display unit (not illustrated) including a liquid crystal display device or the like that displays a state of the processing operation, an image, or the like, and an input unit (not illustrated) used when an operator registers processing content information or the like. The input unit includes at least one of a touch panel provided on the display unit and an external input device such as a keyboard.

### Laser Processing Method

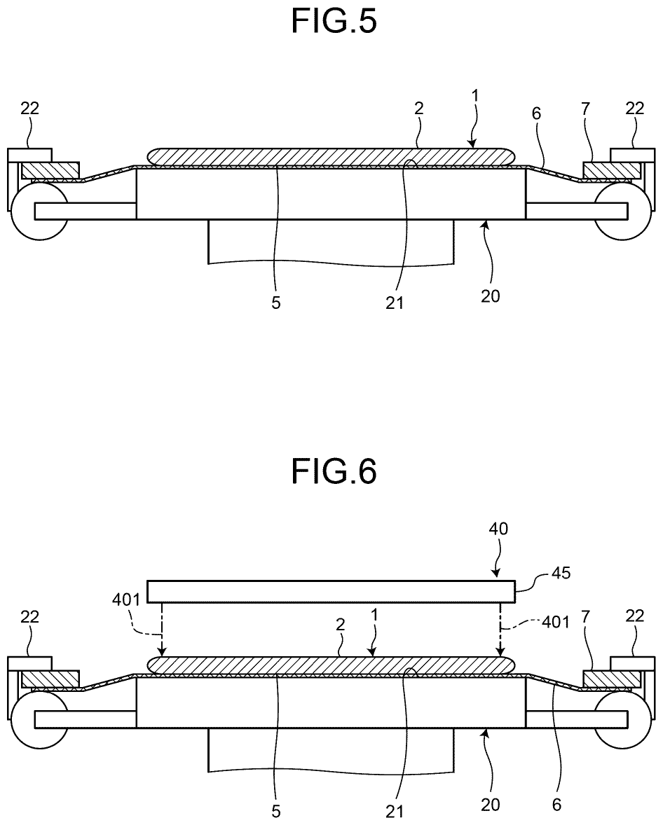

Next, a laser processing method according to the first embodiment will be described. FIG. 4 is a flowchart illustrating a flow of the laser processing method according to the first embodiment. FIG. 5 is a side view schematically illustrating a holding step of the laser processing method illustrated in FIG. 4 in a partial cross section. FIG. 6 is a side view schematically illustrating a laser irradiation step of the laser processing method illustrated in FIG. 4 in a partial cross section.

The laser processing method according to the first embodiment is a method of performing laser processing on the workpiece 1 having the above-described configuration along the planned division lines 3. The laser processing method according to the first embodiment is also a processing operation of the laser processing device 10 having the above-described configuration.

In the laser processing device 10 according to the first embodiment, processing conditions are registered in the control unit 100 by the operator or the like, and the cassette 61 housing therein the workpiece 1 is placed on the cassette elevator 60. When the control unit 100 receives an instruction to start the processing operation from the operator or the like, the laser processing device 10 starts the processing operation, that is, the laser processing method according to the first embodiment. As illustrated in FIG. 4, the laser processing method according to the first embodiment includes a holding step 101 and a laser irradiation step 102.

### Holding Step

The holding step 101 is a step of holding the back surface 5 side of the workpiece 1 by the holding table 20 such that the front surface 2 side of the workpiece 1 is exposed. In the first embodiment, in the holding step 101, the control unit 100 of the laser processing device 10 controls the conveyance unit 80 to take out one workpiece 1 from the cassette 61 and place the workpiece 1 on the pair of guide rails 81.

In the first embodiment, in the holding step 101, the control unit 100 of the laser processing device 10 controls the conveyance unit 80 to place the back surface 5 side of the workpiece 1 on the pair of guide rails 81 on the holding surface 21 of the holding table 20 positioned in the carrying-in/out region. In the first embodiment, in the holding step 101, the control unit 100 of the laser processing device 10 controls the vacuum suction source to suck and hold the back surface 5 side on the holding surface 21 of the holding table 20 via the adhesive tape 6 as illustrated in FIG. 5, thereby exposing the front surface 2 side of the workpiece 1 and clamping the frame 7 with the clamp unit 22.

### Laser Irradiation Step

The laser irradiation step 102 is a step of applying the laser beam 401 from the laser beam irradiation unit 40 along the planned division lines 3 from the front surface 2 side of the workpiece 1 held by the holding table 20. In the first embodiment, in the laser irradiation step 102, the control unit 100 of the laser processing device 10 controls the movement unit 30 to move the holding table 20 toward the processing region, and causes the imaging unit 50 to image the workpiece 1 to perform alignment based on an image obtained by imaging of the imaging unit 50.

In the first embodiment, in the laser irradiation step 102, as illustrated in FIG. 6, the control unit 100 of the laser processing device 10 controls the laser beam irradiation unit 40 to irradiate the front surface 2 of the workpiece 1 with the laser beam 401 in a condition that a focal spot is set onto the planned division line 3 while changing the irradiation position of the laser beam 401 on the front surface 2 by the laser beam scanning unit 44. In the first embodiment, in the laser irradiation step 102, the laser processing device 10 irradiates all the planned division lines 3 of the workpiece 1 held by the holding table 20 with the laser beam 401 to divide the workpiece 1 into the individual devices 4.

In the first embodiment, in the laser irradiation step 102, after the workpiece 1 held by the holding table 20 is divided into the individual devices 4, the control unit 100 of the laser processing device 10 controls the movement unit 30 to position the holding table 20 in the carrying-in/out region, stops suction and holding of the holding table 20, and releases the clamping by the clamp unit 22. In the first embodiment, in the laser irradiation step 102, the control unit 100 of the laser processing device 10 controls the conveyance unit 80 to convey the workpiece 1 from the holding table 20 to the cleaning unit 70, and the control unit 100 controls the cleaning unit 70 to clean the workpiece 1 divided into the individual devices 4.

In the first embodiment, in the laser irradiation step 102, after the control unit 100 controls the conveyance unit 80 to convey the workpiece 1 from the cleaning unit 70 onto the pair of guide rails 81, the laser processing device 10 causes the workpiece 1 placed on the pair of guide rails 81 to be conveyed into the cassette 61. In the first embodiment, the laser processing device 10 sequentially performs laser processing on the workpiece(s) 1 housed in the cassette 61. In the first embodiment, the laser processing device 10 finishes the processing operation when laser processing of all workpieces 1 in the cassette 61 is finished.

As described above, in the first embodiment, in the laser irradiation step 102, when the laser beam irradiation unit 40 having the above-described configuration irradiates the workpiece 1 with the laser beam 401, the laser beam irradiation unit 70 irradiates the workpiece 1 with the laser beam 401 having irradiation energy of 0.01 μJ or more and 10 μJ or less for each focal spot. In the first embodiment, in the laser irradiation step 102, when the laser beam irradiation unit 40 having the above-described configuration irradiates the workpiece 1 with the laser beam 401, the laser beam irradiation unit 70 irradiates the workpiece 1 with the pulse laser beam 401 having a repetition frequency of 1 MHz or more and 100 MHZ or less from the oscillator 46.

As described above, in the laser processing method according to the first embodiment, in the laser irradiation step 102 of irradiating the planned division lines 3 of the workpiece 1 with the laser beam 401, the laser beam scanning unit 44 applies the laser beam 401 while changing the irradiation position of the focal spot of the laser beam 401 on the front surface 2 of the workpiece 1. Therefore, in the laser processing method according to the first embodiment, since the irradiation position of the focal spot of the laser beam 401 is changed by the laser beam scanning unit 44, the scanning speed of the laser beam 401 is increased, an overlap ratio of the focal spots is reduced to reduce the irradiation energy, and a size of generated debris can be relatively reduced.

As a result, the laser processing method according to the first embodiment has an effect of suppressing debris generated when laser processing is performed on the workpiece 1 having the image sensor element as the device 4. The overlap ratio is a ratio of an overlapping area between the focal spots adjacent to each other to an area of the focal spot of the laser beam 401.

Further, in the laser processing method according to the first embodiment, the laser processing is performed by applying the laser beam 401 having the irradiation energy of 10 μJ or less and the repetition frequency of 1 MHz or more for each focal spot. Therefore, as compared with a method of applying the laser beam 401 while relatively moving the workpiece 1 and the laser beam irradiation unit 40 by the movement unit 30, the irradiation energy of the laser beam 401 can be reduced, and in particular, it is possible to suppress debris generated when laser processing is performed on the workpiece 1 having the image sensor element as the device 4.

Further, in the laser processing method according to the first embodiment, laser processing is performed by applying the laser beam 401 having the irradiation energy of 10 μJ or less for each focal spot and the repetition frequency of 1 MHz or more, so that the irradiation energy of the laser beam 401 is reduced, and debris generated at the time of laser processing can be suppressed. Therefore, laser processing can be performed without coating the front surface 2 of the workpiece 1 with a protective film before the laser irradiation step 102.

Note that the present invention is not limited to the above embodiments. That is, various modifications can be made without departing from the gist of the present invention. For example, in the present invention, before the laser irradiation step 102, a liquid water-soluble resin (for example, HogoMax (registered trademark) manufactured by DISCO Corporation) such as polyvinyl alcohol (PVA) or polyvinyl pyrrolidone (PVP) may be applied to the front surface 2 of the workpiece 1, and the liquid water-soluble resin may be dried to coat the entire front surface 2 of the workpiece 1 with a water-soluble protective film.

According to the present disclosure, it is possible to suppress debris generated when laser processing is performed on a workpiece having an image sensor element as a device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laser processing method for performing laser processing on a workpiece along a plurality of planned division lines that intersects each other on a front surface of the workpiece, the workpiece having a plurality of devices formed in respective regions defined by the planned division lines,
each of the devices including an image sensor element,
the laser processing method comprising:
holding a back surface side of the workpiece by a holding table such that a front surface side of the workpiece is exposed; and
applying a laser beam from a laser beam irradiation unit along the planned division lines from the front surface side of the workpiece held by the holding table, wherein
in the applying, the laser beam is applied while changing an irradiation position of the laser beam on the front surface of the workpiece by a laser beam scanning unit disposed between an oscillator that oscillates the laser beam and a condenser that condenses light from the oscillator.

2. The laser processing method according to claim 1, wherein the laser beam scanning unit includes a galvano scanner, a resonant scanner, an acousto-optic polarizer, or a polygon mirror.

3. The laser processing method according to claim 1, wherein
in the applying, a pulse laser beam is applied from the oscillator and irradiation energy for each one irradiation region on the front surface of the workpiece is 10 μJ or less.

4. The laser processing method according to claim 1, wherein
In the applying, a pulse laser beam is applied from the oscillator and a pulse frequency is 1 MHz or more.
